(19) United States
(12) Patent Application Publication
(10) Pub. No.: US 2018/0316840 A1
(43) Pub. Date: Nov. 1, 2018

(54) OPTICAL IMAGE STABILIZATION DEVICES AND METHODS FOR GYROSCOPE ALIGNMENT

(71) Applicant: QUALCOMM Incorporated, San Diego, CA (US)

(72) Inventor: Russel Martin, Menlo Park, CA (US)

(21) Appl. No.: 15/683,176

(22) Filed: Aug. 22, 2017

Related U.S. Application Data
(60) Provisional application No. 62/492,465, filed on May 1, 2017.

(51) Int. Cl. H04N 5/232; G02B 27/64

(52) U.S. Cl. CPC H04N 5/2328; H04N 5/23258; H04N 5/23212; H04N 5/23254; G02B 27/646

(57) ABSTRACT

Disclosed are systems, devices, and methods for calibrating an optical image stabilization (OIS) module in a camera with a gyroscope. The OIS module is calibrated with a gyroscope in a two-step method. The first of the two-step method includes calibrating a lens to image sensor by determining a relationship between lens movement and image movement in the OIS module. The second of the two-step method includes calibrating a gyroscope to the image sensor by determining a relationship between gyroscope movement and image movement in the camera, where the camera includes the OIS module and the gyroscope. The relationship between lens movement and gyroscope movement can be determined to calibrate the OIS module with the gyroscope.

### CROSS-REFERENCE TO RELATED APPLICATIONS

This disclosure claims priority to U.S. Provisional Patent Application No. 62/492,465 (Attorney Docket No. QUALP467P/174105P1), filed May 1, 2017, and entitled “TWO STEP OPTICAL IMAGE STABILIZATION REMOTE GYRO ALIGNMENT,” which is hereby incorporated by reference in its entirety and for all purposes.

### TECHNICAL FIELD

This disclosure relates generally to determining optical and mechanical alignment of an optical image stabilization (OIS) system and, more particularly, to determining optical and mechanical alignment of an OIS system by calibrating the OIS system with a gyroscope in an electronic device.

### DESCRIPTION OF RELATED TECHNOLOGY

Advances in technology have enabled electronic devices, including mobile devices, with an ever increasing set of capabilities. More and more devices include a camera with digital imaging functions. However, due to being hand held, such devices may be subject to blurring and other effects that may reduce the quality of an image. In image stabilization of cameras, technology attempts to compensate for camera motion when a user is taking a picture or recording video. Often, the user's hand that is holding the camera will move inadvertently or shake at the moment of image capture. Image stabilization is intended to counteract these movements, thereby improving the sharpness and overall quality of images produced by a camera.

Digital image stabilization refers to stabilization of an image after it has been captured or recorded. That is, image data already recorded by the camera can be modified electronically or by software after its capture to compensate for camera motion. For example, software-implemented algorithms may reduce warping, distortion, or other perspective artefacts after-the-fact in digital image stabilization. In contrast, optical image stabilization refers to stabilization of physical parts or components (e.g., lens, sensor, etc.) to counteract inadvertent camera motion during capture. In optical image stabilization, the camera may be equipped with additional electro-mechanical components that aim to compensate for hand motion, camera shake, and other such artefacts as they happen.

More and more electronic devices not only include a camera with digital imaging functions, but include motion sensors (e.g., gyroscopes) for detecting motion of the electronic device. A gyroscope is a measuring instrument that detects an angle and an angular velocity of an object along three, relatively orthogonal, axes. Measurements made by the gyroscope can assist in determining the compensatory motion of physical parts or components of the camera for counteracting inadvertent camera motion during capture.

### SUMMARY

The devices, systems, and methods of this disclosure each have several aspects, no single one of which is solely responsible for the desirable attributes disclosed herein.

One aspect of the subject matter of this disclosure can be implemented in a method. The method includes calibrating lens movement to image movement in an optical image stabilization (OIS) module, where the OIS module includes a lens and an image sensor optically coupled with the lens. Calibrating the lens movement to image movement comprises moving the lens relative to a first stationary target, recording lens movement and a direction of an image of the first stationary target on the image sensor, and determining a relationship between lens movement and image movement in the OIS module. The method further includes calibrating gyroscope movement to image movement in an electronic device, where the electronic device includes the OIS module and a gyroscope separate from the OIS module. Calibrating gyroscope movement to image movement includes moving the electronic device relative to a second stationary target, recording gyroscope movement and a direction of an image of the second stationary target on the image sensor, and determining a relationship between gyroscope movement and image movement in the electronic device.

In some implementations, the method further includes combining the relationship between lens movement and image movement and the relationship between gyroscope movement and image movement to determine a relationship between gyroscope movement and lens movement. The relationship between the gyroscope movement and the lens movement can include a rotation matrix. In some implementations, the method further includes providing the OIS module in the electronic device after calibrating lens movement to image movement. In some implementations, the OIS module further includes an actuator for moving the lens relative to the image sensor, and a position sensor for determining a position of the lens relative to the image sensor, the position sensor providing feedback to the actuator. In some implementations, the OIS module does not include any gyroscope. In some implementations, calibrating the gyroscope movement to image movement includes maintaining the lens in a fixed position. In some implementations, calibrating the lens movement to image movement includes maintaining the image sensor in a fixed position.

Another innovative aspect of the subject matter described in this disclosure can be implemented in a method. The method includes receiving data regarding a relationship between lens movement and image movement from an OIS module in an electronic device, where the OIS module includes a lens, an image sensor, and an actuator configured to move the lens relative to the image sensor. The method further includes calibrating gyroscope movement to image movement in the electronic device. Calibrating gyroscope movement to image movement includes detecting movement of the electronic device relative to a stationary target, recording gyroscope movement and a direction of an image of the stationary target on the image sensor, and determining a relationship between gyroscope movement and image movement in the electronic device.

In some implementations, the method further includes combining the relationship between lens movement and image movement and the relationship between gyroscope movement and image movement to determine a relationship between gyroscope movement and lens movement. In some implementations, the relationship between lens movement and image movement in the OIS module includes a 2×2 rotation matrix, and the relationship between gyroscope movement and lens movement includes a 3×2 rotation matrix. In some implementations, the data regarding the relationship between the lens movement and the image movement includes data regarding lens movement across a plurality of angles and corresponding image movement of an image target on the image sensor.

Another innovative aspect of the subject matter described in this disclosure can be implemented in a method. The method includes calibrating lens movement to image movement in an optical image stabilization (OIS) module, where the OIS module includes a lens, an image sensor, and an actuator configured to move the lens relative to the image sensor. Calibrating the lens movement to image movement includes detecting a stationary target outside the OIS module, detecting movement of a lens relative to the stationary target, recording lens movement and a direction of an image of the stationary target on the image sensor, and determining a relationship between lens movement and image movement in the OIS module. The method further includes providing data regarding the relationship between lens movement and image movement to an electronic device when the OIS module is in the electronic device, where the electronic device includes a gyroscope separate from the OIS module, and where the electronic device is configured to determine a relationship between gyroscope movement and image movement.

In some implementations, the data regarding the relationship between the lens movement and the image movement in the OIS module includes a rotation matrix. In some implementations, the data regarding the relationship between lens movement and image movement in the OIS module includes lens movement across a plurality of angles and corresponding image movement of the stationary target on the image sensor. In some implementations, the electronic device is configured to combine the relationship between gyroscope movement and image movement with the relationship between lens movement and image movement to define a relationship between gyroscope movement and lens movement.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

Like reference numbers and designations in the various drawings indicate like elements.

FIGS. 1A and 1B show schematic illustrations of the effects of inadvertent hand shaking on images with and without a correction element.

FIG. 2 shows a perspective view of a schematic illustration of an example optical image stabilization (OIS) module according to some implementations.

FIG. 3A shows a block diagram representation of an example camera configured to implement an OIS module according to some implementations.

FIGS. 3B and 3C show block diagram representations of an example OIS module according to some implementations.

FIG. 4 shows a block diagram representation of an example device including a camera, an OIS module with a gyroscope, and a motion processing module with a gyroscope according to some implementations.

FIG. 5 shows a block diagram representation of an example device including a camera, an OIS module without a gyroscope, and a motion processing module with a gyroscope according to some implementations.

FIG. 6 shows a flow diagram illustrating an example method of calibrating lens movement to gyroscope movement in an electronic device according to some implementations.

FIG. 7A shows a schematic illustration of calibrating lens movement to image movement in an OIS module.

FIG. 7B shows a schematic illustration of calibrating gyroscope movement to image movement in an electronic device.

FIG. 8 shows a schematic illustration of a plot indicating image movement relative to lens motion or gyroscope motion.

FIG. 9 shows a schematic illustration of angular misalignment and various coordinate axes of a lens, an image sensor, and a gyroscope for determining angular misalignment.

FIG. 10A shows a flow diagram illustrating an example method of calibrating lens movement to image movement in an OIS module according to some implementations.

FIG. 10B shows a flow diagram illustrating an example method of calibrating gyroscope movement to image movement in an electronic device according to some implementations.

FIG. 11 shows a flow diagram illustrating an example method of calibrating lens movement to gyroscope movement in an electronic device according to some implementations.

FIG. 12 shows a flow diagram illustrating an example method of calibrating lens movement to gyroscope movement in an electronic device according to some implementations.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that includes an OIS system as disclosed herein for calibration with a gyroscope separate from the OIS system. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, wristbands, rings, headbands, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, automatic teller machines (ATMs), parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

An electronic device, such as a mobile device, can include a camera, a gyroscope, and an OIS module configured to move one or more parts of the camera to compensate for camera motion. The gyroscope and the OIS module may be separate from each other in the electronic device. A gyroscope separate from the OIS module may be misaligned with the OIS module unless calibrated. Calibrating the OIS module with the gyroscope in the electronic device may be accomplished in multiple steps or operations. Such calibration may occur by calibrating lens movement to image movement in the OIS module followed by calibrating gyroscope movement to image movement in the electronic device that includes the OIS module.

To calibrate lens movement to image movement, a lens can be moved relative to a stationary target, lens movement and a direction of an image of the stationary target on an image sensor can be recorded, and a relationship between lens movement and image movement can be determined. To calibrate gyroscope movement and image movement, the electronic device can be moved relative to a stationary target, gyroscope movement and a direction of an image of the stationary target on the image sensor can be recorded, and a relationship between gyroscope movement and image movement can be determined. The relationship between lens movement and image movement and the relationship between gyroscope movement and image movement can be combined to determine a relationship between lens movement and gyroscope movement.

Particular implementations of the subject matter described in this disclosure can be implemented to realize one or more of the following potential advantages. Incorporating an OIS module without a gyroscope into an electronic device can reduce assembly costs and form factor, thereby reducing a total cost and size of a camera. A gyroscope on a main circuit board of the electronic device may interface with the OIS module. Calibrating lens movement in the OIS module to gyroscope movement in the electronic device reduces angular misalignment between the OIS module and the gyroscope, where such calibration eliminates or minimizes the need for perfect alignment. The calibration accounts for angular misalignment between the OIS module and the gyroscope to reduce the effects of blurring and other effects associated with inadvertent camera motion. This allows for higher resolution cameras with improved image quality.

Image stabilization is used to reduce blurring and other effects associated with camera motion during the time an image sensor of a camera is exposed to a capturing environment. User movements of a camera can be characterized by pan and tilt movements, where the angular movements are known as yaw and pitch, respectively. Hand tremors often affect movements in at least two axes, which can adversely affect image quality. Rotation about the lens axis (roll) can also occur, but it cannot be compensated by moving the lens and, so, is not considered in OIS. Image stabilization techniques, including OIS, aims to reduce such effects on image quality.

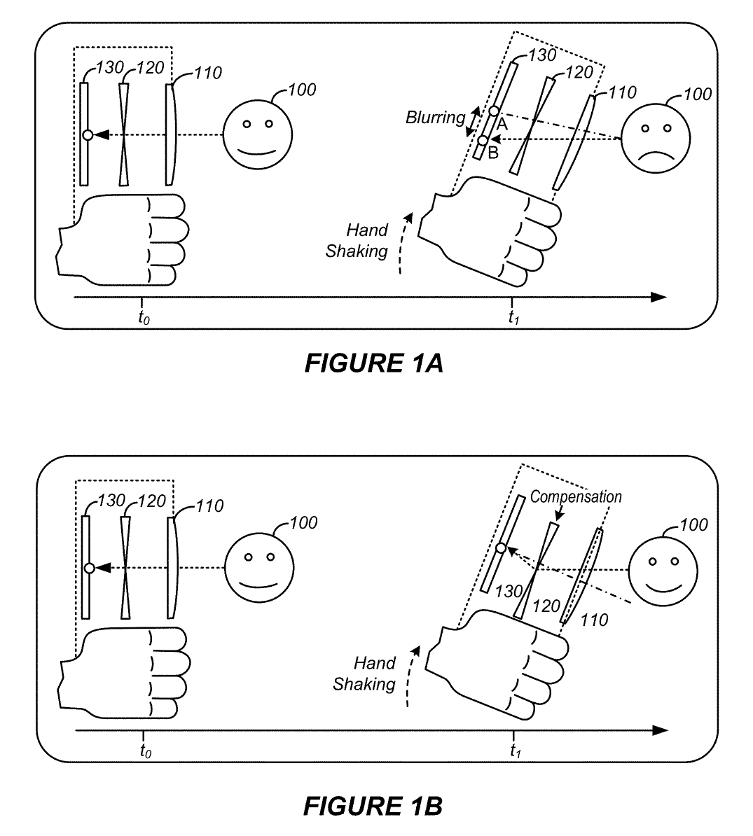

FIG. 1A shows a schematic illustration of the effects of inadvertent hand shaking on images without correction by a correction element. Typically, hand shaking can result in vibration identifiable as an oscillating signal with an amplitude and frequency, such as an amplitude of about 0.5 degrees and a frequency in the range of about 2 Hz to about 20 Hz. In FIG. 1A, a target 100 can be captured by a camera via an optical path through a lens 110 of the camera. At time t₀ the optical path passes through the lens 110 and a correction element 120 and onto an image sensor or imager 130. Between time t₀ and t₁, inadvertent hand shaking occurs that changes the optical path from the target 100 to the image sensor 130. The inadvertent hand shaking causes the lens 110 to move, thereby changing the optical path when the correction element 120 does not correct for the change in the optical path. The image on the image sensor 130 shifts from point A to point B at time t₁. The result can be blurring of the image on the image sensor 130.

FIG. 1B shows a schematic illustration of the effects of inadvertent hand shaking on images with correction by a correction element. As in FIG. 1A, a target 100 can be captured by a camera via an optical path through a lens 110 of the camera at time t₀. In spite of the inadvertent hand shaking between time t₀ and t₁, the image on the image sensor 130 does not shift because of compensation by the correction element 120. The correction element 120 can move between time t₀ and t₁ to re-adjust the optical path so that the image on the image sensor is the same at time t₀ and t₁. OIS is a mechanical technique used in cameras to stabilize an image by controlling the optical path to the image sensor 130. In some implementations, the correction element 120 can be a lens or another moving part of the camera that corrects the optical path, such as a part that corrects a position of the lens 110.

An OIS module may be implemented with a camera to control the optical path to an image sensor. The OIS module may be a lens-based stabilization system or a sensor-based stabilization system. In a lens-based stabilization system, one or more parts of an optical lens attached to the camera are moved by an actuator or driver, which compensates for camera movement. Conversely, in a sensor-based stabilization system, an image sensor is moved by an actuator or driver to perform such compensation.

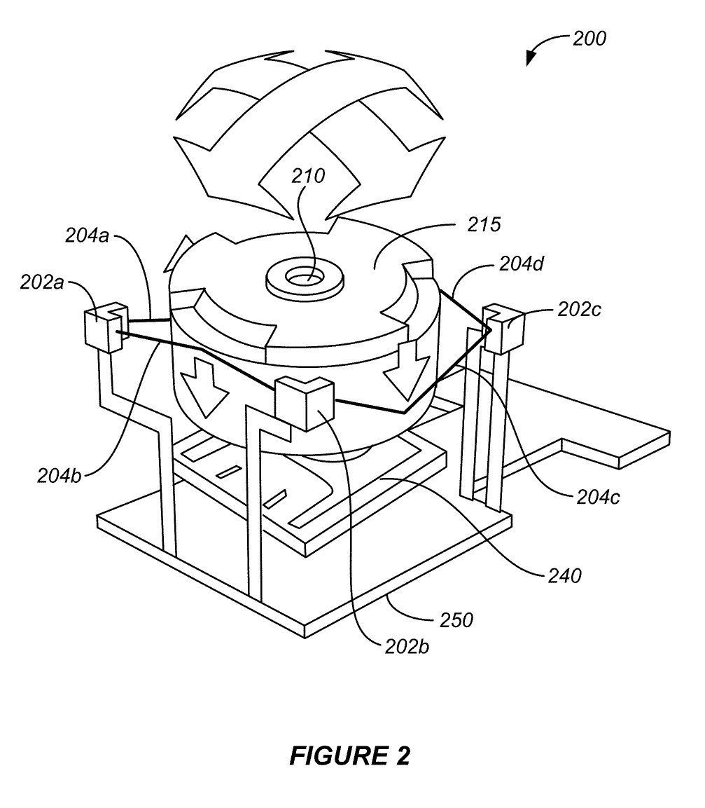

FIG. 2 shows a perspective view of a schematic illustration of an example OIS module according to some implementations, where the OIS module is a lens-based stabilization system. A lens-based OIS module 200 includes an optical lens 210 and an image sensor 240. The optical lens 210 may be supported in a barrel or holder 215. The optical lens 210 may be configured to direct an optical path of an image onto the image sensor 240. In some implementations, the image sensor 240 is supported on a printed circuit board (PCB) 250.

Movement of the optical lens 210 in at least two axes (e.g., x-axis and y-axis) may be controlled by an actuator. In some implementations, the actuator may be based on any suitable technology for controlling movement of the optical lens 210, such as liquid lens, shape memory alloy, piezoelectric motor, voice coil motor technology, or other linear actuator. Typically, movement of the optical lens 210 may be controlled by one or more voice coil motors (VCMs). VCMs utilize the interaction between current-carrying coil windings and magnets, where current applied to the coil windings generate electromagnetic fields that interact with the magnets to apply a force on the barrel or holder 215 of the optical lens 210. The force causes the barrel or holder 215 of the optical lens 210 to move by a distance related to the applied current, where the distance can be directly proportional to the applied current in the zeroth order of approximation. For example, the VCMs may include a pair of first magnets and a pair of second magnets disposed on both sides of an optical axis, respectively. The VCMs may further include a pair of first coils and a pair of second coils disposed on both sides of the optical axis, respectively. The actuator may include springs 204a, 204b, 204c, and 204d supported by supports 202a, 202b, 202c, and 202d. The actuator may control a position of the barrel or holder 215 using springs 204a, 204b, 204c, and 204d when a force is exerted upon them.

A position of the optical lens 210 may be detected using one or more position sensors, such as one or more Hall sensors. The actuator may move the position of the optical lens 210 using force generated by one or more VCMs. The actuator receives position information of the optical lens 210 from the one or more Hall sensors, and moves the position of the optical lens 210 using the one or more VCMs. Based on the detected position of the optical lens 210, a controller may send one or more control algorithms for moving the position of the optical lens 210 accordingly. Thus, the position of the optical lens 210 may be controlled by a feedback loop using VCMs for actuation and Hall sensors for position detection.

Camera motion or camera shake can be measured by observing angular displacements. A gyroscope can measure angular displacement of a camera. Generally, a gyroscope outputs an angular rate, where the angular rate can be filtered and integrated to generate an angle or angular displacement. In some implementations, limits on the angle or angular displacement can be imposed so that the gyroscope accounts for hand shaking and hand tremors. That way, the gyroscope accounts for small vibrations in the range of a few Hertz to several tens of Hertz. In some implementations, with respect to filtering angular motion being provided to an OIS module, the gyroscope movement can be limited to movement within plus or minus three degrees, plus or minus two degrees, or plus or minus one degree. Measurements made by the gyroscope can be sent to the controller for determining appropriate lens movement by the actuator, where the controller provides angular rotation data for the actuator for positioning and holding the optical lens 210.

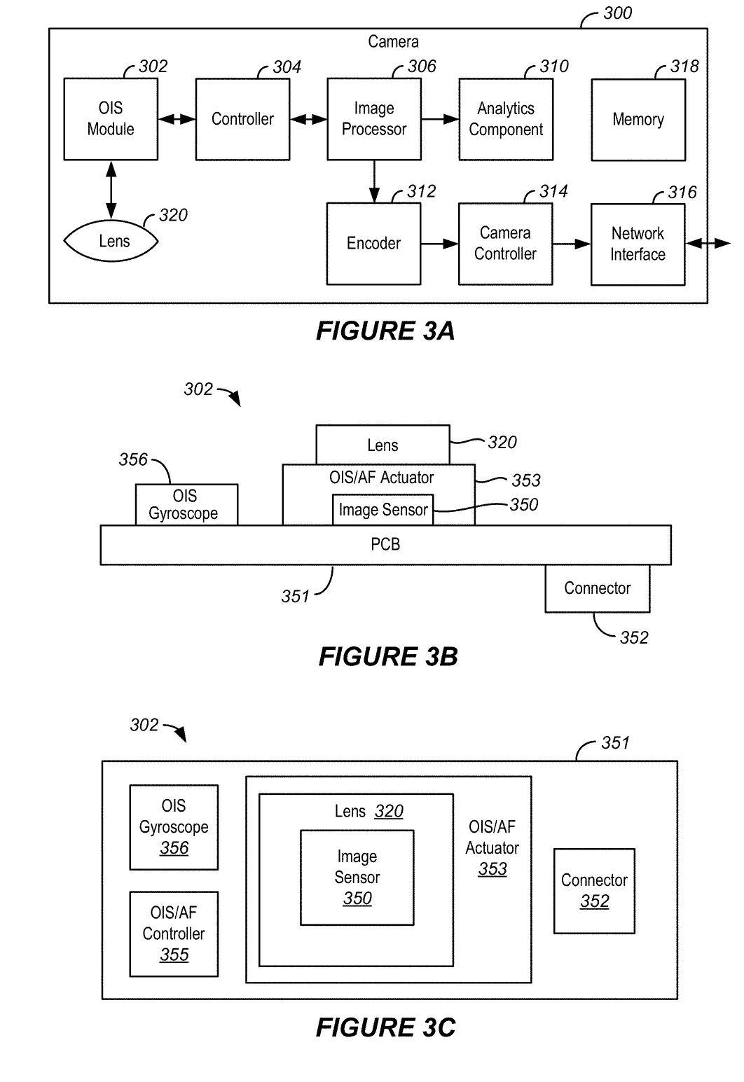

FIG. 3A shows a block diagram representation of an example camera configured to implement an OIS module according to some implementations. A camera 300 may be a digital or still camera. In some implementations, the camera 300 is a standalone camera. In some implementations, the camera 300 is embedded in an electronic device, such as a mobile phone (e.g., smartphone), a tablet computer, a laptop, a handheld gaming device, and a wearable device (e.g., smart watch).

The camera 300 includes an OIS module 302, a controller 304, and an image processor 306. The OIS module 302 may also be referred to as a camera module or imaging component. In some implementations, the camera 300 further includes analytics 310, an encoder 312, camera controller 314, network interface 316, and memory 318. At least some of the components of the camera 300 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

The OIS module 302 may include or at least be coupled to a lens 320, where the OIS module 302 is configured to control a position of the lens 320. The OIS module 302 may be part of an imaging component that may function with the controller 304 to capture images of a target or a scene. In addition to controlling the position of the lens 320 for optical image stabilization using the OIS module 302, the imaging component may also control various aspects of the camera's operation such as, for example, aperture opening amount, exposure time, etc. Image processor 306 may process incoming digital signals into frames of pixels and process each frame.

FIGS. 3B and 3C show block diagram representations of an example OIS module according to some implementations. The OIS module 302 may include an image sensor 350 mounted on a PCB 351. In some implementations, the image sensor 350 includes a charge-coupled device (CCD) or complementary metal-oxide semiconductor (CMOS) image sensor for converting an incident object image to electrical image signals. The OIS module 302 may further include an OIS/auto-focus (AF) actuator 353 coupled to the lens 320, where the OIS/AF actuator 353 is configured to move and hold the position of the lens 320 based on signals received from the OIS/AF controller 355. As discussed above, the OIS/AF actuator 353 may be based on one or more VCMs, where the one or more VCMs include magnets and coils such that the magnets in conjunction with the coils produce a force for moving the lens 320. The OIS/AF actuator 353 may further include position sensors, such as Hall sensors, for detecting the position of the lens 320. In some implementations, OIS and AF functions are integrated together in the OIS/AF actuator 353 and the OIS/AF controller 355 for size and efficiency reasons. However, it will be understood that in some implementations, the OIS actuator 353 may be separate from an AF actuator, and the OIS controller 355 may be separate from an AF controller.

The lens 320 and the OIS/AF actuator 353 may be positioned adjacent to the image sensor 350 so that the image sensor 350 is optically coupled with the lens 320. For example, the lens 320 and the OIS/AF actuator 353 may be positioned above the image sensor 350 as shown in FIG. 3B, though it will be understood that in some implementations the lens 320 and the OIS/AF actuator 353 may be positioned below the image sensor 350. The OIS module 302 may further include an OIS gyroscope 356 on the PCB 351, where the OIS gyroscope 356 can detect and measure physical movement of the camera 300. In some implementations, the OIS gyroscope 356 and the OIS/AF controller 355 may be disposed on the PCB 351. Based at least in part on the measurements received from the OIS gyroscope 356, the OIS/AF controller 355 may communicate to the OIS/AF actuator 353 and determine a direction and movement of the lens 320. In some implementations, the OIS module 302 further includes a connector 352, which can be used to facilitate electrical connection among various components of the OIS module 302 and the camera 300.

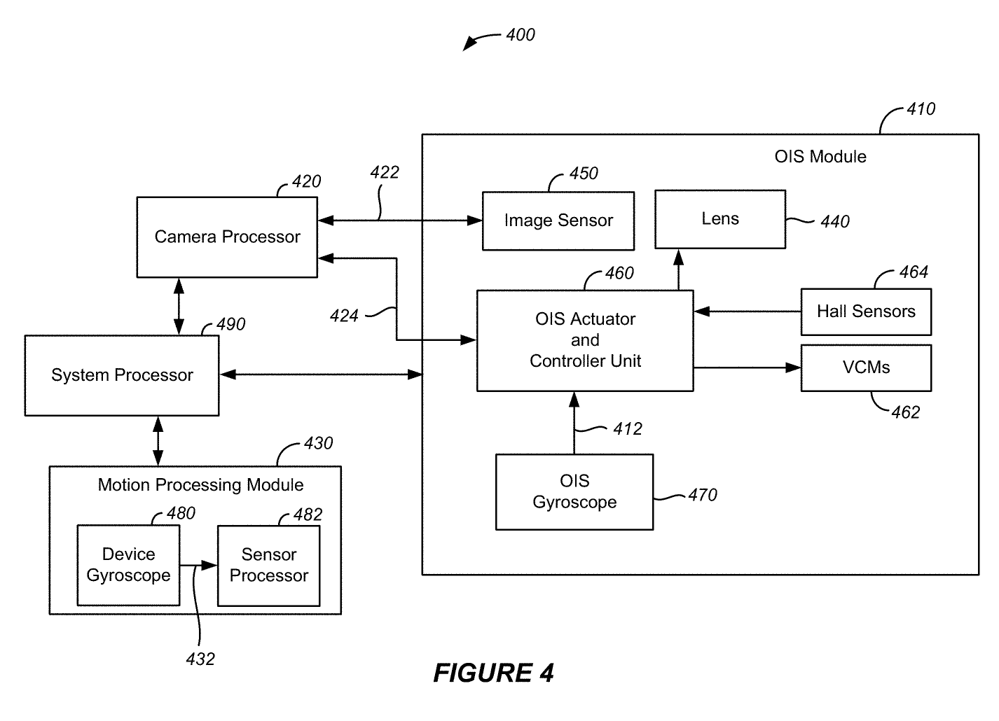

FIG. 4 shows a block diagram representation of an example device including a camera, an OIS module with a gyroscope, and a motion processing module with a gyroscope according to some implementations. Typically, a device 400 includes a camera module or OIS module 410 with an OIS gyroscope 470. The OIS module 410 may further include a lens 440 and an image sensor 450, where the lens 440 can be positioned proximate to the image sensor 450 so that the image sensor 450 is optically coupled with the lens 440. The lens 440 is coupled to an OIS actuator and controller unit 460 for controlling movement of the lens 440 for image stabilization. As shown in FIG. 4, the OIS actuator and controller unit 460 is coupled with one or more VCMs 462 for applying electromagnetic force from one or more VCM coils and VCM magnets to actuate the lens 440. The OIS actuator and controller unit 460 is further coupled with one or more Hall sensors 464 for detecting a position of the lens 440. The one or more Hall sensors 464 and the one or more VCMs 462 create a feedback loop for controlling movement of the lens 440 for image stabilization. The OIS gyroscope 470 in the OIS module 410 is coupled to the OIS actuator and controller unit 460 through a communication interface 412. In some implementations, the communication interface 412 is serial peripheral interface (SPI).

Having the OIS gyroscope 470, the lens 440, and the image sensor 450 in the OIS module 410 allows for the OIS gyroscope 470 and the image sensor 450 to be calibrated with the lens 440 so that their alignment is generally acceptable. The OIS gyroscope 470 and the image sensor 450 may be formed on a common substrate, such as a PCB. The lens 440 may be coupled to the common substrate via the OIS actuator and controller unit 460 formed on the common substrate. Accordingly, in some implementations, the OIS gyroscope 470 and the image sensor 450 may be aligned with the lens 440 since such components may be assembled together with respect to a common substrate.

The device 400 may further include a camera processor 420, where the camera processor 420 interfaces with the OIS module 410. The camera processor 420 may be part of a camera of the device 400 that controls and processes the image from the image sensor 450 as well as optics of the image sensor 450. The camera may be any suitable type of image taking device and may be incorporated within the device 400, where the device 400 may constitute a mobile phone (e.g., smartphone), a tablet computer, a laptop, a handheld gaming device, or a wearable device (e.g., smart watch). The camera may be configured to receive light from outside the device 400 through the lens 440 to form an image on the image sensor 450. The camera processor 420 may be equipped with auto-focus (AF) and/or optical image stabilization (OIS) capabilities with respect to the light received by the camera. The camera may include various components such as components shown in FIG. 3A, where the components may include a lens, an image sensor, an image processor, a controller, an encoder, a memory, an analytics component, and a network interface. The lens and the image sensor may be part of an OIS module. Various camera functions and operations may be controlled by the camera processor 420. For example, the camera processor 420 may control aperture opening amount, exposure time, white balancing, gamma correction, contrast enhancement, and color correction, among many other camera operations. In some implementations, the camera processor 420 may control and communicate with the image sensor 450 via a communication interface 422, such as a MIPI protocol. In some implementations, the camera processor 420 may control and communicate with the OIS actuator and controller unit 460 via a communication interface 424, such as an inter-integrated circuit (I2C) protocol. An image signal processing (ISP) unit of the camera may process images from the image sensor 450, where the ISP unit may be in communication with the camera processor 420 or may be included in the camera processor 420. The camera processor 420 may control positioning of the lens 440 in the OIS module 410 by interfacing with the OIS actuator and controller unit 460.

The device 400 may further include a motion processing module 430 configured to detect and measure motion of the device 400. The motion processing module 430 may include, for example, accelerometers and gyroscopes. The accelerometers and gyroscopes in the motion processing module 430 may be used in a variety of applications, such as navigation, remote control, displaying a picture in a certain orientation, video game control, etc. The motion processing module 430 may include a device gyroscope 480 for detecting and measuring angular motion of the device 400. The device gyroscope 480 may also be referred to as a main gyroscope or a user interface gyroscope. The device gyroscope 480 may communicate with a processor 482 of the motion processing module 430 via a communication interface 432, such as SPI.

The device 400 may further include a system processor 490 for controlling one or more operations of the device 400. Various components of the device 400 may be coupled to the system processor 490, such as a radio-frequency (RF) component, a battery component, a memory component, etc. In addition, the motion processing module 430 and the camera 420 may be coupled to the system processor 490. In some implementations, the system processor 490 may be a programmable microprocessor, microcomputer, or multiple processor chip or chips that can be configured by software instructions to perform a variety of functions.

As shown in FIG. 4, the device 400 includes an OIS gyroscope 470 with the OIS module 410 and a device gyroscope 480 with the motion processing module 430. In some implementations, the device gyroscope 480 and the OIS module 410 with the OIS gyroscope 470 may be disposed on a main circuit board of the device 400. Having the device gyroscope 480 and the OIS gyroscope 470 results in a redundancy in the device 400. It is also generally more expensive to have both the device gyroscope 480 and the OIS gyroscope 470 on the main circuit of the device 400. Thus, the redundancy can add to the cost, size, and complexity of the device 400.

It is desirable to reduce the costs associated with a device having a camera without degrading the performance of the device. Either a device gyroscope or an OIS gyroscope can be removed from the device to eliminate redundancy.

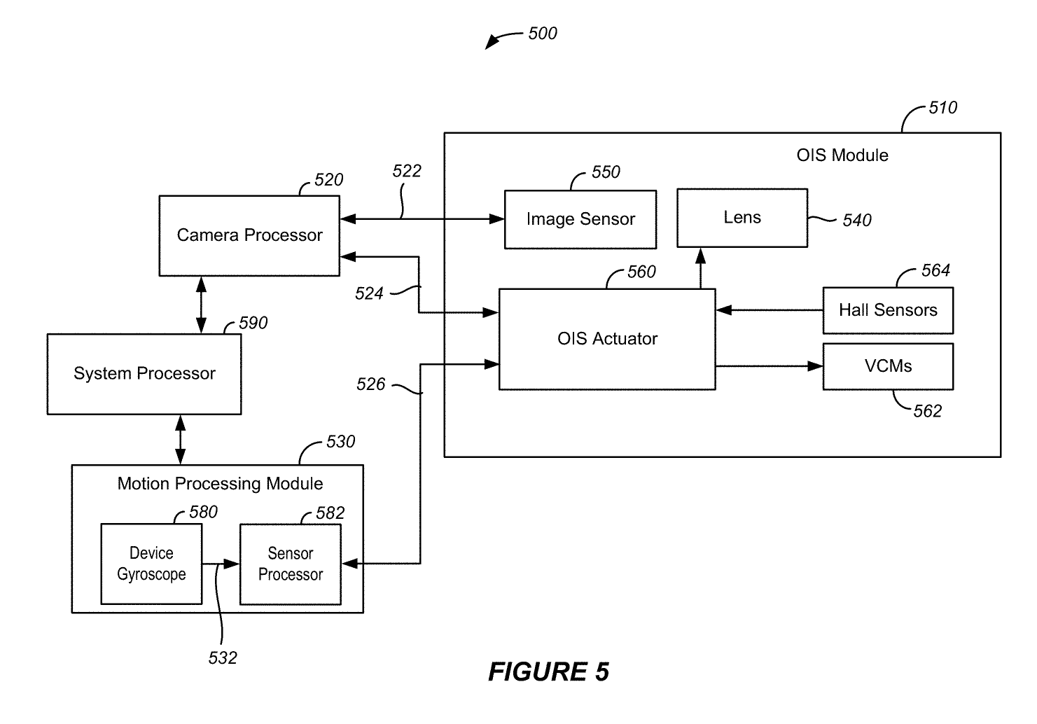

FIG. 5 shows a block diagram representation of an example device including a camera, an OIS module without a gyroscope, and a motion processing module with a gyroscope according to some implementations. A device 500 includes a camera module or OIS module 510 without a gyroscope. The OIS module 510 may include a lens 540 and an image sensor 550, where the lens 540 may be positioned proximate to the image sensor 550 so that the image sensor 550 is optically coupled with the lens 540. The lens 540 is coupled to an OIS actuator 560 for controlling movement of lens 540 for image stabilization. The OIS actuator 560 may be configured to move and hold a position of the lens 540 based on signals received from a processor 582 of a motion processing module 530. The OIS actuator 560 is coupled with one or more VCMs 562 for applying electromagnetic force from one or more VCM coils and VCM magnets to actuate the lens 540. The OIS actuator 560 is further coupled with one or more Hall sensors 564 for detecting a position of the lens 540. The one or more Hall sensors 564 and the one or more VCMs 562 create a feedback loop for controlling movement of the lens 540 for image stabilization. As shown in FIG. 5, the OIS module 510 does not have a gyroscope and does not have a separate controller integrated with the OIS actuator 560 as in FIG. 4. Instead, the OIS module 510 may utilize a device gyroscope 580 to detect and measure angular motion, and the OIS module 510 may utilize a processor 582 of the motion processing module 530 to communicate with and control the OIS actuator 560. In some implementations, the processor 582 of the motion processing module 530 communicates via a communication interface 526. For example, the communication interface 526 may be an I2C protocol. The device gyroscope 580 may also be referred to as a main gyroscope or a user interface gyroscope.

The device 500 further includes a camera processor 520, where the camera processor 520 interfaces with the OIS module 510. The camera processor 520 may be part of a camera of the device 500 that controls and processes the image from the image sensor 550 as well as optics of the image sensor 550. The camera may be any suitable type of image taking device and may be incorporated within the device 500, where the device 500 may constitute a mobile phone (e.g., smartphone), a tablet computer, a laptop, a handheld gaming device, or a wearable device (e.g., smart watch). The camera may be configured to receive light from outside the device 500 through the lens 540 to form an image on the image sensor 550. The camera processor 520 may be equipped with auto-focus and/or optical image stabilization (OIS) capabilities with respect to the light received by the camera. The camera may include various components such as components shown in FIG. 3A, where the components may include a lens, an image sensor, an image processor, a controller, an encoder, a memory, an analytics component, and a network interface. The lens and the image sensor may be part of an OIS module. Various camera functions and operations may be controlled by the camera processor 520. For example, the camera processor 520 may control aperture opening amount, exposure time, white balancing, gamma correction, contrast enhancement, and color correction, among many other camera operations. In some implementations, the camera processor 520 may control and communicate with the image sensor 550 via a communication interface 522, such as a MIPI protocol. In some implementations, the camera processor 520 may control and communicate with the OIS actuator 560 via a communication interface 524, such as an I2C protocol. An image signal processing (ISP) unit of the camera may process images from the image sensor 550, where the ISP unit may be in communication with the camera processor 520 or may be included in the camera processor 520. The camera processor 520 may control the positioning of the lens 540 in the OIS module 510 by interfacing with the OIS actuator 560.

The device 500 may further include a motion processing module 530 configured to detect and measure motion of the device 500. The motion processing module 530 may include, for example, accelerometers and gyroscopes. The accelerometers and gyroscopes in the motion processing module 530 may be used in a variety of applications, such as navigation, remote control, displaying a picture in a certain orientation, video game control, etc. The motion processing module 530 may include a device gyroscope 580 for detecting and measuring angular motion of the device 500. The device gyroscope 580 may communicate with a processor 582 of the motion processing module 530 via a communication interface 532 such as SPI.

The device 500 may further include a system processor 590 for controlling one or more operations of the device 500. Various components of the device 500 may be coupled to the system processor 590, such as an RF component, a battery component, a memory component, etc. In addition, the motion processing module 530 and the camera 520 may be coupled to the system processor 590. In some implementations, the system processor 590 may be a programmable microprocessor, microcomputer, or multiple processor chip or chips that can be configured by software instructions to perform a variety of functions.

In FIG. 5, the OIS module 510 and the motion processing module 530 are separate from each other and formed independently. Typically, an OIS module 510 is manufactured separately and subsequently assembled into the device 500. A vendor or manufacturer of the OIS module 510 is unable to perform an alignment calibration with the device gyroscope 580 in the device 500. Thus, various parts of the OIS module 510, including the lens 540, the image sensor 550, and the OIS actuator 560, may not be aligned with the device gyroscope 580.

The OIS module 510 itself and the image sensor 550 may be subject to tolerances in assembly with respect to the device gyroscope 580, which can result in angular misalignment relative to the device gyroscope 580. Moreover, the OIS actuator 560 is a mechanical component subject to tolerances in assembly with the OIS module 510, and there may also be angular misalignment relative to other parts of the OIS module 510 and the device gyroscope 580. Any misalignment from assembly of the OIS module 510 and the device gyroscope 580, especially angular misalignment between the OIS actuator 560 and the device gyroscope 580, may result in blurring of an image. Even small angular misalignments, such as about 2 degrees or greater, 1 degree or greater, 0.75 degrees or greater, or 0.5 degrees or greater may result in blurring of an image.

By way of an illustration, if the device 500 with the device gyroscope 580 is moved in an x-direction, the device gyroscope 580 may detect and measure such movement in the x-direction. However, if the image sensor 550 is not aligned with the device gyroscope 580, then movement of the device 500 in the x-direction may result in movement of the image sensor 550 in an x-direction and partly in a y-direction. And if the OIS actuator 560 is not aligned with one or both of the image sensor 550 and the device gyroscope 580, a measurement by the device gyroscope 580 in the x-direction may be even more skewed by the OIS actuator 560 when controlling compensating movement of the lens 540 relative to the image sensor 550.

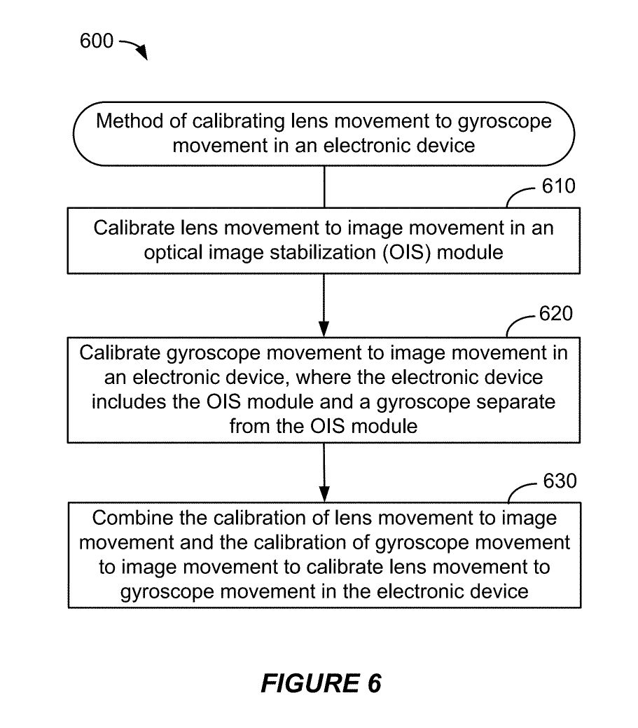

A multi-step method is provided to calibrate the relative angular motion between the OIS actuator 560 coupled to the lens 540 and the device gyroscope 580. The calibration provides angular alignment between lens movement by the lens 540 and gyroscope movement measured by the device gyroscope 580. At least one of the steps in the multi-step method includes calibrating lens movement by the lens 540 to image movement by the image sensor 550 in the OIS module 510. When the OIS module 510 is assembled or otherwise placed in the device 500, at least one of the steps in the multi-step method further includes calibrating gyroscope movement measured by the device gyroscope 580 to image movement by the image sensor 550 in the device 500. Using the calibration performed by the multi-step method, a relationship between gyroscope movement and lens movement is determined so that the OIS module 510 is calibrated with the device gyroscope 580. Details regarding the calibration steps in the multi-step method are described below with respect to FIGS. 6, 7A-7B, 8-9, 10A-10B, and 11-12.

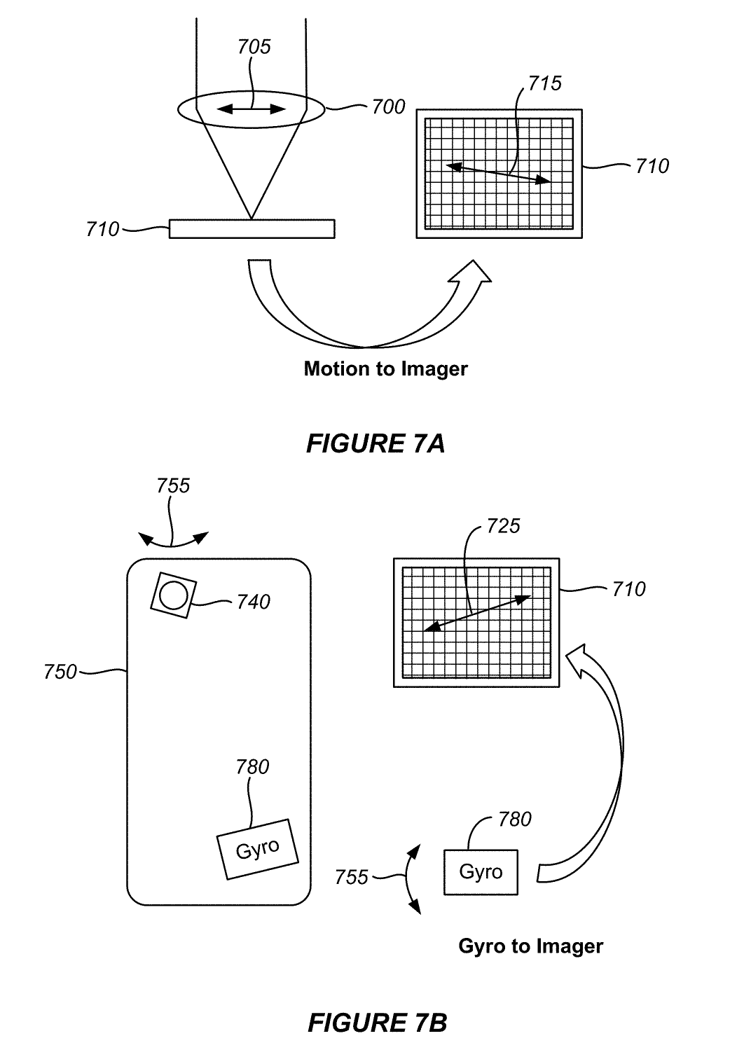

FIG. 6 shows a flow diagram illustrating an example method of calibrating lens movement to gyroscope movement in an electronic device according to some implementations. It will be understood that a process 600 shown in FIG. 6 may be performed in a different order or with different, fewer, or additional operations. Aspects of the process 600 in FIG. 6 may be described with respect to the schematic illustrations shown in FIGS. 7A-7B and 8-9.

The process 600 relates to a method of calibrating lens movement to gyroscope movement in an electronic device. Otherwise, angular motion detected by a gyroscope in the electronic device may be misaligned with compensating motion associated with moving a lens for optical image stabilization. Calibration of lens movement and gyroscope movement may occur in multiple steps or operations so that the lens is aligned with the gyroscope of the electronic device.

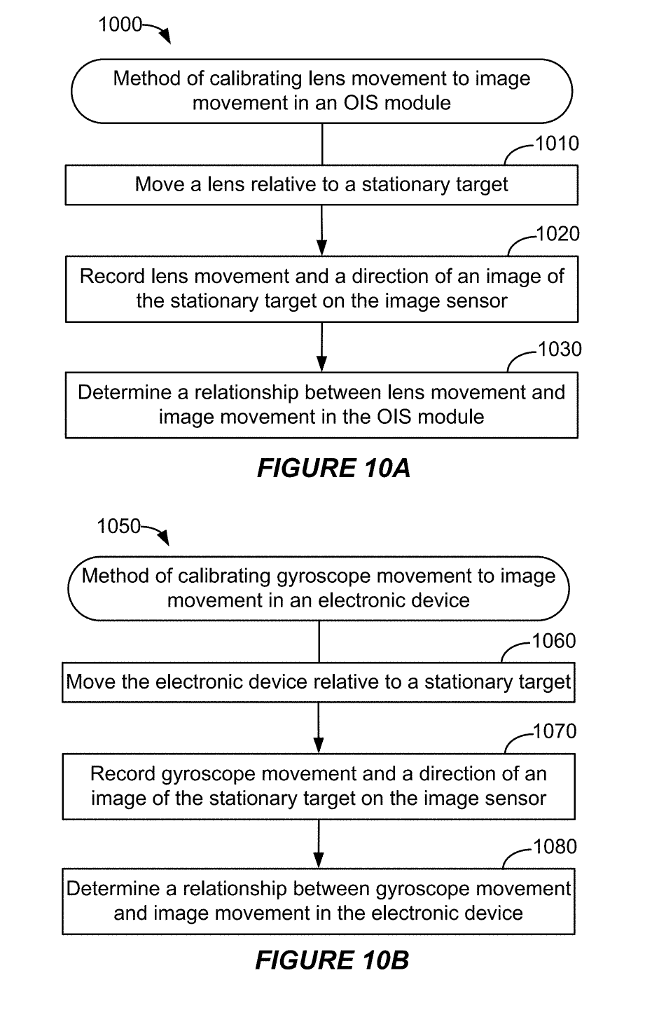

At block 610 of the process 600, lens movement is calibrated to image movement in an OIS module. Details regarding calibrating lens movement to image movement in the OIS module are shown in FIG. 10A. Prior to incorporating, assembling, or placing the OIS module into the electronic device, components of the OIS module itself are calibrated with respect to one another. An OIS module may include a lens, an image sensor, and an actuator configured to move the lens relative to the image sensor for image stabilization. The image sensor may be optically coupled with the lens. The actuator may include one or both of an OIS actuator and an AF actuator. The OIS module does not include a gyroscope. Before being implemented in the electronic device, the OIS module neither has a gyroscope as one of its parts nor is in communication with a gyroscope.

FIG. 7A shows a schematic illustration of calibrating lens movement to image movement in an OIS module. A lens 700 of a camera is positioned above an image sensor 710 and directs light from outside of the camera to the image sensor 710. An image captured by the camera is formed on the image sensor 710. The image sensor 710 may convert the incident image into electrical image signals. In some implementations, the camera captures an image of a stationary object (not shown) outside the camera so that the image of the stationary object is formed on the image sensor 710.

In FIG. 7A, calibrating lens movement 705 to image movement 715 can include capturing a first image of the stationary object on the image sensor 710, moving the lens 700 relative to the stationary object, and capturing a second image of the stationary object on the image sensor 710. Moving the lens 700 according to lens movement 705 can be a rotation of the lens 700 along two axes or more, such as an x-axis and a y-axis that are orthogonal or substantially orthogonal to one another. For example, lens movement 705 can be within a range of about plus or minus three degrees, plus or minus two degrees, or plus or minus one degree in at least two orthogonal directions. Image movement 715 can be recorded by comparing a position of the first image to a position of the second image. Image movement 715 of the first image to the second image can occur in a range of motion in at least two orthogonal axes (e.g., x-axis, y-axis). An array of points in a two-dimensional coordinate system can be obtained based on the image movement 715. Thus, image movement 715 in an x-y plane can be recorded as it relates to lens movement 705. A relationship between image movement 715 and lens movement 705 can be established, and an angular offset between the lens 700 and the image sensor 710 can be calculated. The angular offset can be incorporated in a rotation matrix, such as a 2×2 rotation matrix, given by:

$$R ( θ ) = ( \begin{matrix}cos θ & - sin θ \\ sin θ & cos θ\end{matrix} )$$

Returning to FIG. 6, at block 620 of the process 600, gyroscope movement is calibrated to image movement in an electronic device. Details regarding calibration of gyroscope movement to image movement in the electronic device are shown in FIG. 10B. The electronic device includes the OIS module and a gyroscope separate from the OIS module. As used herein, “separate” may refer to being manufactured or assembled separately, functioning as discrete or distinct parts, and/or being disposed outside of each other. The gyroscope may detect and measure physical movement of the electronic device, particularly angular motion of the electronic device. The gyroscope may be configured to detect and measure angular movements in at least a yaw axis and a pitch axis of the electronic device, though the gyroscope may be configured to also detect and measure angular movements in a roll axis of the electronic device. In some implementations, the process 600 further includes incorporating, assembling, or placing the OIS module into the electronic device prior to calibrating gyroscope movement to image movement at block 620 but after calibrating lens movement to image movement at block 610. In some implementations, the gyroscope in the electronic device is on a main circuit board of the electronic device. In some implementations, the electronic device includes a motion processing module including a processor and the gyroscope in electrical communication with the processor.

FIG. 7B shows a schematic illustration of calibrating gyroscope movement to image movement in an electronic device. An electronic device 750 includes a camera 740 with an OIS module (not shown) and a gyroscope 780 separate from the camera 740. An image is captured by the camera 740 so that an image is formed on the image sensor 710. In some implementations, the camera 740 captures an image of a stationary object (not shown) so that the image of the stationary object is formed on the image sensor 710.

In FIG. 7B, calibrating gyroscope movement 755 to image movement 725 can include capturing a first image of the stationary object on the image sensor 610, moving the electronic device 750 relative to the stationary object, and capturing a second image of the stationary object on the image sensor 710. It will be understood that moving the electronic device 750 correlates to gyroscope movement 755. Moving the electronic device 750 according to gyroscope movement 755 can occur along a given axis of rotation, such as the yaw, pitch, or roll axis of rotation. It will be understood that rotation in the roll axis of rotation (z-axis) may be assumed to not affect image movement 725 in the image sensor 710. In some implementations, gyroscope movement 755 in FIG. 7B can be greater than the lens movement 705 in FIG. 7A. For example, gyroscope movement 755 can be within a range of about plus or minus 40 degrees, plus or minus 20 degrees, plus or minus 10 degrees, plus or minus 5 degrees in at least two orthogonal directions. In moving the gyroscope 780 by moving the electronic device 750, the lens 700 of the camera 740 is maintained in a fixed position. Or, if the lens 700 of the camera 740 is moved, it is moved by a known amount. The image sensor 710 may also be maintained in a fixed position or moved by a known amount if not maintained in a fixed position. Image movement 725 can be recorded by comparing a position of the first image to a position of the second image. Image movement 725 of the first image to the second image can occur in a range of motion in at least two orthogonal axes (e.g., x-axis, y-axis). An array of points in a two-dimensional coordinate system can be obtained based on the image movement 725. Thus, image movement 725 in an x-y plane can be recorded as it relates to gyroscope movement 755. A relationship between image movement 725 and gyroscope movement 755 can be established, and an angular offset between the gyroscope 780 and the image sensor 710 can be calculated. The angular offset can be incorporated in a rotation matrix, such as a 3×2 rotation matrix or 3×3 rotation matrix. Rotation in the z-axis (roll) by the electronic device 750 can be understood to not affect image movement 725. A 3×3 rotation matrix, if rotation occurs about an z-axis, is given by:

$$Rz ( θ ) = ( \begin{matrix}cos θ & - sin θ & 0 \\ sin θ & cos θ & 0 \\ 0 & 0 & 1\end{matrix} )$$

Returning to FIG. 6, at block 630 of the process 600, the calibration of lens movement to image movement and the calibration of gyroscope movement to image movement are combined to calibrate lens movement to gyroscope movement in the electronic device. That way, a relationship between lens movement and gyroscope movement can be established. This enables the gyroscope to be calibrated to an OIS module and to correct for angular alignment issues with a lens of the OIS module. Rather than trying to perform the calibration between the gyroscope and the lens within the electronic device itself, the calibration is divided into at least two operations or two steps shown in blocks 610 and 620. The lens is calibrated against the image sensor in the OIS module in block 610, and the gyroscope is calibrated against the image sensor in the electronic device in block 620.

In some implementations, combining the calibration of lens movement to image movement and the calibration of gyroscope movement to image movement includes combining the rotation matrix for the relationship between lens movement and image movement and the rotation matrix for the relationship between gyroscope movement and image movement. For example, the 2×2 rotation matrix expressing the relationship between lens movement and image movement can be multiplied with a 3×2 rotation matrix expressing the relationship between gyroscope movement and image movement. In some implementations, combining the calibration of lens movement to image movement and calibration of gyroscope movement to image movement includes adding the angular misalignment between the lens and image sensor with the angular misalignment between the image sensor and the gyroscope.

The resulting 2×3 rotation matrix may be used to convert gyroscope angular motion to lens movement. Three gyroscope directions in a 3×1 matrix are input and multiplied with the resulting 2×3 rotation matrix to output two lens movement directions in a 2×1 matrix. This may be expressed in the equation below. The lens movement directions may be subsequently used for input into an actuator for control of lens position in optical image stabilization, where Ø represents the angular misalignment between the gyroscope and lens.

$$( \begin{matrix}{x}^{′} \\ {y}^{′}\end{matrix} ) = ( \begin{matrix}cos ∅ & - sin ∅ & 0 \\ sin ∅ & cos ∅ & 0\end{matrix} ) ( \begin{matrix}x \\ y \\ z\end{matrix} )$$

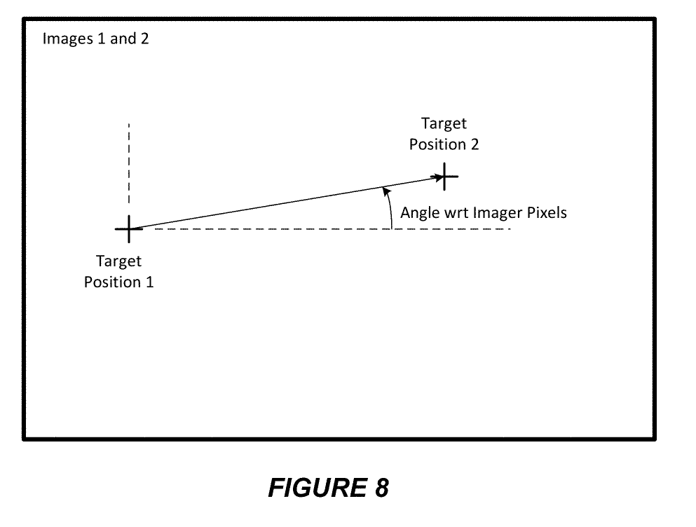

FIG. 8 shows a schematic illustration of a plot indicating image movement relative to lens motion or gyroscope motion. Recording image movement can occur by recording movement of a first image of a stationary target at target position 1 to a second image of the stationary target at target position 2. The first and second image of the stationary target can be represented by a “+” sign. Any shape can be localized to serve as a “+” sign so that any center of an image of the stationary target can be identified. That way, movement of the image can be tracked from target position 1 to target position 2. A vector may be associated between the locations of the image from target position 1 to target position 2. The angle of the vector with respect to the coordinates of the image sensor defines the angular misalignment. If the recorded image movement is for lens motion, then the angular misalignment is between the lens and the image sensor. If the recorded image movement is based on gyroscope motion, then the angular misalignment is between the gyroscope and the image sensor. A rotation matrix may be determined from the motion of an image relative to the motion of the lens (e.g., step one of a two-step calibration process) or relative to the motion of the gyroscope (e.g., step two of the two-step calibration process).

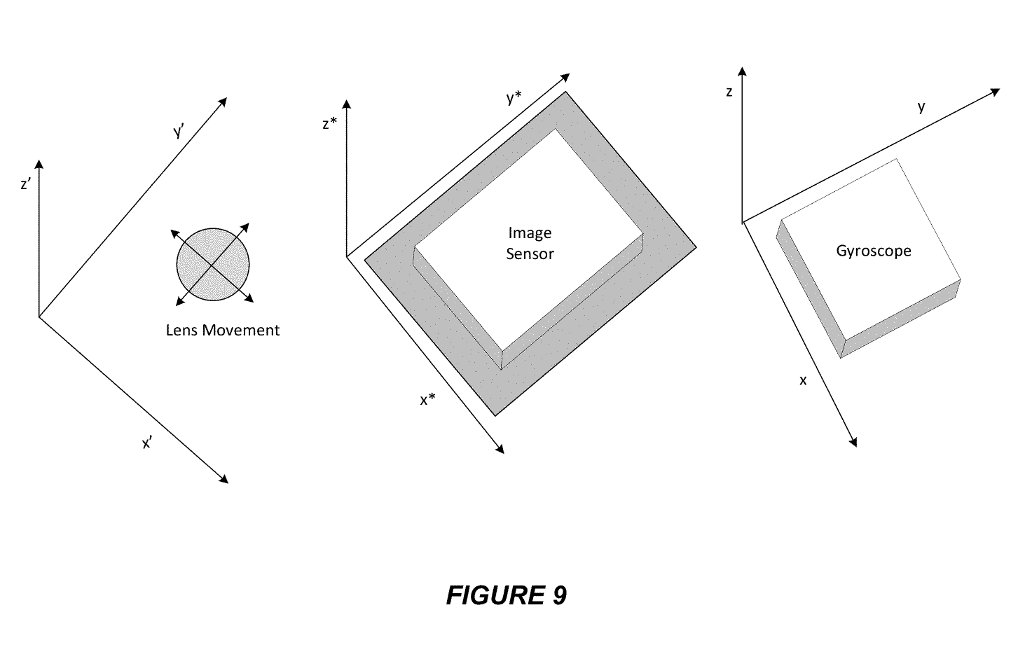

FIG. 9 shows a schematic illustration of angular misalignment and various coordinate axes of a lens, an image sensor, and a gyroscope for determining angular misalignment. As shown in FIG. 9, the coordinate axes of a lens can be represented by an x′-y′-z′ coordinate system, the coordinate axes of an image sensor can be represented by an x*-y*-z* coordinate system, and the coordinate axes of a gyroscope can be represented by an x-y-z coordinate system. The coordinate axes may be associated with placement of the lens, the image sensor, and the gyroscope, respectively. The coordinate axes of the lens, the image sensor, and the gyroscope show the angular misalignment between the lens and the image sensor, between the image sensor and the gyroscope, and between the gyroscope and the lens. For the sake of simplicity, assuming the angular difference is rotation about the z-axis, then z, z*, and z′ coordinate axis is the same and misalignment may be characterized by a single angle between the gyroscope and the lens. However, it will be understood that there may be misalignment in the z-direction (e.g., having a gyroscope that is not perfectly flat), so that misalignment may be characterized by multiple angles between the gyroscope and lens. In such instances, a 3×3 rotation matrix may represent three-dimensional rotation about the x-direction, about the y-direction, and about the z-direction separately.

In FIG. 9, a lens may move (e.g., tilt) along one or two axes, such as its x′-axis and y′-axis. Such tilt movement along the one or two axes of rotation may be shown by the big arrows in FIG. 2. Motion in the x*-y* plane may be recorded by the image sensor. An angle of a vector from an image moving from target position 1 to target position 2, such as shown in FIG. 8, may be calculated to define the angular misalignment between the lens in the x′-y′ coordinate axes and the image sensor in the x*-y* coordinate axes. The image sensor may define an x*-y*-z* coordinate system different than the x′-y′-z′ coordinate system defined by the lens. An offset between the coordinate systems may represent the angular misalignment, which can be seen in FIG. 9. Furthermore, an electronic device may move along one, two, or three axes, such as its x-axis, y-axis, and z-axis. The movement along the one, two, or three axes of rotation may be recorded by the gyroscope of the electronic device. Motion in the x*-y* plane may be recorded by the image sensor. An angle of a vector from an image moving from target position 1 to target position 2, such as shown in FIG. 8, may be calculated to define the angular misalignment between the gyroscope in the x-y-z coordinate axes and the image sensor in the x*-y* coordinate axes. The gyroscope may define an x-y-z coordinate system different than the x*-y*-z* coordinate system defined by the image sensor. An offset between the coordinate systems may represent the angular misalignment. The angular misalignment between the gyroscope in the x-y-z coordinate axes and the image sensor in the x*-y* coordinate axes, and the angular misalignment between the lens in the x′-y′ coordinate axes and the image sensor in the x*-y* coordinate axes may be combined to determine the angular misalignment between the gyroscope in the x-y-z coordinate axes and the lens x′-y′ coordinate axes. Ascertaining the angular misalignment between the gyroscope in the x-y-z coordinate axes and the lens in the x′-y′ coordinate axes enables determination of a 3×2 or 3×3 rotation matrix. Thus, a magnitude of rotation (x, y, z) measured by the gyroscope may translate to a magnitude of rotation applied to the lens (x′, y′).

FIG. 10A shows a flow diagram illustrating an example method of calibrating lens movement to image movement in an OIS module according to some implementations. It will be understood that a process 1000 shown in FIG. 10A may be performed in a different order or with different, fewer, or additional operations.

Prior to calibrating the lens movement to image movement in the OIS module in the process 1000, various components of the OIS module may be calibrated with the lens. One or more Hall sensors may be coupled with the lens for position detection and one or more VCMs may be coupled with the one or more Hall sensors and the lens for actuating the lens. The position of the lens may be controlled by a feedback loop using the one or more Hall sensors and the one or more VCMs. In some implementations, the process 1000 may include calibrating the lens with the one or more Hall sensors. This may include measuring and correcting for offset and gain by moving the lens across a range of motion. In some implementations, the process 1000 may include calibrating the lens and the one or more Hall sensors with the one or more VCMs. This may include measuring the gain (e.g., electrical current to position) of the one or more VCMs and setting the input range from the one or more Hall sensors appropriate for feedback. In some implementations, the process 800 further includes determining a scale factor for a set position of the feedback loop with the one or more Hall sensors and the one or more VCMs. Since VCMs run on electrical current rather than degrees, an angle as an input is properly converted to electrical current to control the signals in the VCMs.

The operations in the process 1000 may be performed prior to assembling the OIS module with another device. The process 1000 may include a series of operations for calibrating the OIS module, including calibrating one or more Hall sensors with a lens, one or more VCMs with the lens and the one or more Hall sensors, and an image sensor with the lens. In some implementations, calibrating lens movement with image movement in the process 1000 can begin at block 1010 and finish at block 1030.

At block 1010 of the process 1000, a lens is moved relative to a stationary target. The OIS module may be positioned to view a stationary target to allow determination of a location of an image on the image sensor. A position of the lens and a position of the image on the image sensor may be recorded. The lens is moved to a different position relative to the stationary target, causing a position of the image on the image sensor to move. The lens may be moved along two axes, such as an x-axis and a y-axis that are orthogonal or substantially orthogonal to one another. The lens may be moved within a range of about plus or minus three degrees, plus or minus two degrees, or plus or minus one degree in at least two orthogonal directions.

At block 1020 of the process 1000, lens movement and a direction of an image of the stationary target on the image sensor are recorded. The location of the image of the stationary target on the image sensor is moved and such movement is recorded. Lens movement along at least two orthogonal or substantially orthogonal directions is also recorded. Lens position affects the position of the image of the stationary target on the image sensor. A series of images of the stationary target on the image sensor may be captured across two orthogonal directions of lens movement. By way of an example, multiple data points for lens movement are recorded and multiple data points for image movement are recorded.

At block 1030 of the process 1000, a relationship between lens movement and image movement in the OIS module is determined. In some implementations, the relationship may be expressed as a rotation matrix, such as a 2×2 rotation matrix. The relationship may convert lens position to the direction of an image on the image sensor. For example, image movement may have a magnitude of rotation given by (x, y) and lens movement may have a magnitude of rotation given by (x′, y′), and the relative angle between the image sensor and lens movement is given by θ. The relative angle may represent the angular misalignment between the lens and the image sensor. The 2×2 rotation matrix converts the magnitude of rotation of the image movement to the magnitude of rotation of the lens movement.

$$( \begin{matrix}{x}^{′} \\ {y}^{′}\end{matrix} ) = ( \begin{matrix}cos θ & - sin θ \\ sin θ & cos θ\end{matrix} ) ( \begin{matrix}x \\ y\end{matrix} )$$

In some implementations, the relationship between lens movement and image movement may be stored in a memory in the OIS module. In some implementations, the multiple data points recorded for lens movement along with the multiple data points recorded for corresponding image movement are stored in the memory. In some implementations, the rotation matrix expressing the relationship between lens movement and image movement is stored in the memory. The OIS module may be subsequently incorporated, assembled, or otherwise placed in an electronic device, such as an electronic device with a camera, where the incorporated OIS module includes the stored data regarding the relationship between lens movement and image movement.

FIG. 10B shows a flow diagram illustrating an example method of calibrating gyroscope movement to image movement in an electronic device according to some implementations. It will be understood that a process 1050 shown in FIG. 10B may be performed in a different order or with different, fewer, or additional operations.

Prior to calibrating gyroscope movement to image movement in the electronic device, an OIS module is incorporated, assembled, or otherwise placed in the electronic device. The electronic device includes a gyroscope. The OIS module may be placed in the electronic device so that a relative position of the OIS module is fixed with respect to the gyroscope. The OIS module is separate from the gyroscope of the electronic device. For example, both the OIS module and the gyroscope may be soldered onto a circuit board of the electronic device. The OIS module includes a lens and an image sensor, where the image sensor is optically coupled with the lens. In some implementations, the OIS module further includes an actuator for controlling a movement of the lens. In some implementations, the OIS module further includes one or more position sensors for determining a position of the lens relative to the image sensor. The OIS module does not include a gyroscope. The OIS module is calibrated so that a relationship between lens movement and image movement is established. In some implementations, the calibration of the OIS module may occur according to the operations of the process 1000.

The operations in the process 1050 may be performed after calibrating the OIS module and after assembling the calibrated OIS module with the electronic device. The process 1050 may be performed before, during, or after manufacture of the electronic device. In some implementations, calibrating gyroscope movement with image movement in the process 1050 can begin at block 1060 and finish at block 1080.

At block 1060 of the process 1050, the electronic device is moved relative to a stationary target. The lens in the OIS module is held in a fixed position. In addition, the image sensor in the OIS module is held in a fixed position. In some implementations, block 1060 may be performed by a user of the electronic device or by a manufacturer, vendor, or retailer of the electronic device. The electronic device may be positioned to view a stationary target to allow determination of a location of an image of the stationary target on the image sensor. The gyroscope of the electronic device detects and measures angular motion of the electronic device. Thus, gyroscope movement is correlated with movement of the electronic device. The electronic device may be moved within a range of about plus or minus 40 degrees, plus or minus 20 degrees, plus or minus 10 degrees, or plus or minus 5 degrees in at least two orthogonal directions. Though the electronic device is moved in at least two orthogonal directions, corresponding gyroscope movement may be recorded in at least two or three orthogonal directions.

At block 1070 of the process 1050, gyroscope movement and a direction of an image of the stationary target on the image sensor are recorded. The location of the image of the stationary target on the image sensor is moved and such movement is recorded. Gyroscope movement in at least two or three orthogonal directions is also recorded. Gyroscope movement can be determined based on filtering and integration of the gyroscope output, which typically outputs an angular rate. A position of the electronic device relative to the stationary target affects a position of the image of the stationary target on the image sensor. A series of images of the stationary target on the image sensor may be captured across two or three orthogonal directions of gyroscope movement. By way of an example, multiple data points for gyroscope movement are recorded and multiple data points for image movement are recorded.

At block 1080 of the process 1050, a relationship between gyroscope movement and image movement in the electronic device is determined. In some implementations, the relationship may be expressed as a rotation matrix, such as a 3×2 rotation matrix. The relationship may convert an angular position of the gyroscope to a direction of an image on the image sensor. For example, gyroscope movement may have a magnitude of rotation given by (x, y, z) and image movement may have a magnitude of rotation given by (x*, y*), and the relative angle between the image sensor and lens movement is given by θ. The relative angle may represent the angular misalignment between the gyroscope and the image sensor. Rotation in the z-axis by the gyroscope can be understood to not affect image movement on the image sensor. The 3×2 rotation matrix, which can also be expressed as a 2×3 rotation matrix, converts the magnitude of rotation of the gyroscope movement to the magnitude of rotation of the image movement.

$$( \begin{matrix}x * \\ y *\end{matrix} ) = ( \begin{matrix}cos θ & - sin θ & 0 \\ sin θ & cos θ & 0\end{matrix} ) ( \begin{matrix}x \\ y \\ z\end{matrix} )$$

The relationship between gyroscope movement and image movement provides an association of gyroscope movement to image position in at least two orthogonal directions. The relationship between gyroscope movement and image movement can provide the angular offset between the gyroscope and the image sensor. The relationship between gyroscope movement and image movement determined in the process 1050 may be combined with the relationship between lens movement and image movement determined in the process 1000. Accordingly, a relationship between gyroscope movement and lens movement may be calculated. That way, gyroscope angles may be converted to lens movement angles and scaled to control input to the OIS module for image stabilization in the electronic device.

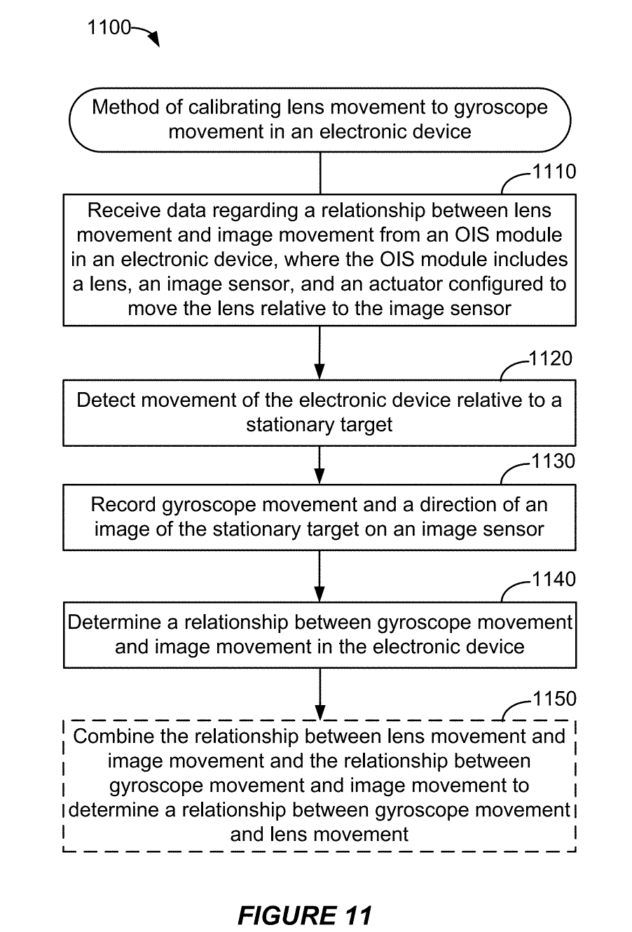

FIG. 11 shows a flow diagram illustrating an example method of calibrating lens movement to gyroscope movement in an electronic device according to some implementations. It will be understood that a process 1100 shown in FIG. 11 may be performed in a different order or with different, fewer, or additional operations. The process 1100 may be performed by one or more hardware or software components in the electronic device, such as a microprocessor, or, any conventional processor, controller, microcontroller, or state machine.

At block 1110 of the process 1100, data regarding a relationship between lens movement and image movement from an OIS module in an electronic device is received. The OIS module includes a lens, an image sensor optically coupled with the lens, and an actuator configured to move the lens relative to the image sensor. The OIS module may include memory storing the data regarding the relationship between lens movement and image movement in the OIS module. In some implementations, the data regarding the relationship between the lens movement and the image movement includes data regarding lens movement across a plurality of angles and corresponding image movement of an image target on the image sensor. In some implementations, the relationship between lens movement and image movement in the OIS module is expressed as a rotation matrix, such as a 2×2 rotation matrix. The electronic device may be received by a user, manufacturer, vendor, retailer, or other entity for testing and/or calibration of the electronic device. Calibration of the gyroscope occurs in blocks 1120-1140 or blocks 1120-1150, where calibration of the gyroscope includes calibrating gyroscope movement to image movement in the electronic device.

At block 1120 of the process 1100, movement of the electronic device is detected relative to a stationary target. In some implementations, the stationary target is a test fixture that is captured by the electronic device prior to movement. The movement of the electronic device may be initiated by the user, manufacturer, vendor, retailer, or other entity. The movement may be created by natural movements of users holding the mobile device in their hand without bracing it on a stationary object. The lens in the OIS module is held in a fixed position, or at least moved by a known amount if not held in a fixed position. In addition, the image sensor in the OIS module is held in a fixed position. The electronic device may be positioned to view a stationary target to allow determination of a location of an image of the stationary target on the image sensor. The gyroscope of the electronic device detects and measures angular motion of the electronic device. Thus, gyroscope movement is correlated with movement of the electronic device. Movement of the electronic device occurs within a range of about plus or minus 40 degrees, plus or minus 20 degrees, plus or minus 10 degrees, or plus or minus 5 degrees in at least two orthogonal directions. Though the electronic device is moved in at least two orthogonal directions, corresponding gyroscope movement may be recorded in at least two or three orthogonal directions. In some implementations, movement of the electronic device is performed by the user, manufacturer, vendor, retailer, or other entity according to a testing/calibration protocol.

At block 1130 of the process 1100, gyroscope movement and a direction of an image of the stationary target on the image sensor are recorded. The location of the image of the stationary target on the image sensor is moved and such movement is recorded. Gyroscope movement in at least two or three orthogonal directions is also recorded. Gyroscope movement can be determined based on filtering and integration of the gyroscope output, which typically outputs an angular rate. A position of the electronic device relative to the stationary target affects a position of the image of the stationary target on the image sensor. A series of images of the stationary target on the image sensor may be captured across two or three orthogonal directions of gyroscope movement. By way of an example, multiple data points for gyroscope movement are recorded and multiple data points for image movement are recorded.

At block 1140 of the process 1100, a relationship between gyroscope movement and image movement in the electronic device is determined. In some implementations, the relationship may be expressed as a rotation matrix, such as a 3×2 rotation matrix. The relationship may convert an angular position of the gyroscope to a direction of an image on the image sensor. For example, gyroscope movement may have a magnitude of rotation given by (x, y, z) and image movement may have a magnitude of rotation given by (x*, y*), and the relative angle between the image sensor and lens movement is given by θ. Rotation in the z-axis by the gyroscope can be understood to not affect image movement on the image sensor.

Optionally, at block 1150 of the process 1100, the relationship between lens movement and image movement and the relationship between gyroscope movement and image movement are combined to determine a relationship between gyroscope movement and lens movement. In some implementations, the relationship between gyroscope movement and lens movement is expressed as a 3×2 or 3×3 rotation matrix. The 3×2 or 3×3 rotation matrix may be used to convert gyroscope angular motion to lens movement. For example, three gyroscope directions in a 3×1 matrix are input and multiplied with the 2×3 or 3×3 rotation matrix to output lens movement directions in a 2×1 or 3×1 matrix.

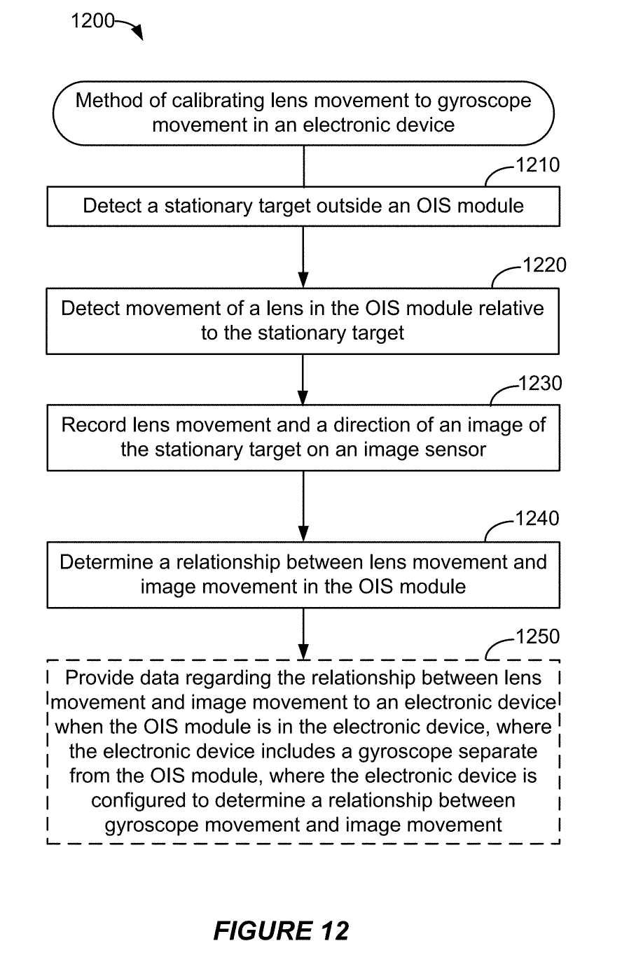

FIG. 12 shows a flow diagram illustrating an example method of calibrating lens movement to gyroscope movement in an electronic device according to some implementations. It will be understood that a process 1200 shown in FIG. 12 may be performed in a different order or with different, fewer, or additional operations. The process 1200 may be performed by one or more hardware or software components in the electronic device, such as a microprocessor, or, any conventional processor, controller, microcontroller, or state machine.

An OIS module may be manufactured with the one or more hardware or software components configured to calibrate the OIS module. The OIS module includes a lens, an image sensor optically coupled with the lens, and an actuator configured to move the lens relative to the image sensor. Calibration of the OIS module may include calibration of one or more Hall sensors with the lens, one or more VCMs with the lens and the one or more Hall sensors, and the image sensor with the lens. Such calibration may occur at blocks 1210-1240 or blocks 1210-1250, where calibration of the OIS module includes calibrating lens movement to image movement in the OIS module.

At block 1210 of the process 1200, a stationary target outside the OIS module is detected. The stationary target may be a test fixture that is captured by the OIS module prior to moving the lens of the OIS module. The OIS module may record a position of an image of the stationary target on the image sensor.

At block 1220 of the process 1200, movement of the lens is detected in the OIS module relative to the stationary target. The movement may be initiated by a manufacturer of the OIS module or other entity, where movement may be controlled automatically or manually. When the lens is moved to a different position relative to the stationary target, a position of the image of the stationary target on the image sensor is caused to move. The lens may be moved along two axes, such as an x-axis and a y-axis that are orthogonal or substantially orthogonal to one another. The lens may be moved within a range of about plus or minus three degrees, plus or minus two degrees, or plus or minus one degree in at least two orthogonal directions.

At block 1230 of the process 1200, lens movement and a direction of an image of the stationary target on the image sensor are recorded. The location of the image of the stationary target on the image sensor is moved and such movement is recorded. Lens movement along at least two orthogonal or substantially orthogonal directions is also recorded. Lens position affects a position of the image of the stationary target on the image sensor. A series of images of the stationary target on the image sensor may be captured across two orthogonal directions of lens movement. By way of an example, multiple data points for lens movement are recorded and multiple data points for image movement are recorded.

At block 1240 of the process 1200, a relationship between lens movement and image movement in the OIS module is determined. In some implementations, the relationship may be expressed as a rotation matrix, such as a 2×2 rotation matrix. The relationship may convert lens position to direction of an image on the image sensor. For example, lens movement may have a magnitude of rotation given by (x, y) and image movement may have a magnitude of rotation given by (x*, y*), and the relative angle between the image sensor and lens movement is given by θ. The 2×2 rotation matrix converts the magnitude of rotation of the lens movement to the magnitude of rotation of the image movement.

Optionally, at block 1250 of the process 1200, data regarding the relationship between lens movement and image movement is provided to an electronic device when the OIS module is in the electronic device, where the electronic device includes a gyroscope separate from the OIS module, and where the electronic device is configured to determine a relationship between gyroscope movement and image movement. The OIS module may include memory storing the data regarding the relationship between lens movement and image movement in the OIS module. In some implementations, the data regarding the relationship between the lens movement and the image movement includes data regarding lens movement across a plurality of angles and corresponding image movement of an image target on the image sensor. In some implementations, the relationship between lens movement and image movement in the OIS module is expressed as a rotation matrix, such as a 2×2 rotation matrix. In some implementations, the electronic device is configured to determine a relationship between gyroscope movement and lens movement by combining the relationship between lens movement and image movement and the relationship between gyroscope movement and image movement. Upon establishing the relationship between gyroscope movement and lens movement, lens movement angles may be subsequently provided as input to a Hall sensor-VCM feedback loop for control of lens position in optical image stabilization when the electronic device is inadvertently moved.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, the structures disclosed in this specification and their structural equivalents thereof, or in any combination thereof. Implementations of the subject matter described in this specification may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module that may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. A method comprising:
calibrating lens movement to image movement in an optical image stabilization (OIS) module, wherein the OIS module includes a lens and an image sensor optically coupled with the lens, and wherein calibrating the lens movement to image movement comprises:
moving the lens relative to a first stationary target;
recording lens movement and a direction of an image of the first stationary target on the image sensor; and
determining a relationship between lens movement and image movement in the OIS module; and
calibrating gyroscope movement to image movement in an electronic device, wherein the electronic device includes the OIS module and a gyroscope separate from the OIS module, and wherein calibrating gyroscope movement to image movement includes:
moving the electronic device relative to a second stationary target;
recording gyroscope movement and a direction of an image of the second stationary target on the image sensor; and
determining a relationship between gyroscope movement and image movement in the electronic device.

2. The method of claim 1, further comprising:
combining the relationship between lens movement and image movement and the relationship between gyroscope movement and image movement to determine a relationship between gyroscope movement and lens movement.

3. The method of claim 2, wherein the relationship between the gyroscope movement and the lens movement includes a rotation matrix.

4. The method of claim 1, further comprising:
providing the OIS module in the electronic device after calibrating lens movement to image movement.

5. The method of claim 1, wherein the OIS module further includes an actuator for moving the lens relative to the image sensor, and a position sensor for determining a position of the lens relative to the image sensor, the position sensor providing feedback to the actuator.

6. The method of claim 5, wherein the position sensor includes one or more Hall sensors and the actuator includes one or more voice coil motors (VCMs).

7. The method of claim 1, wherein the OIS module does not include any gyroscope.

8. The method of claim 1, wherein the relationship between the lens movement and the image movement in the OIS module includes a rotation matrix.

9. The method of claim 1, wherein calibrating the gyroscope movement to image movement includes maintaining the lens in a fixed position.

10. The method of claim 1, wherein calibrating the lens movement to image movement includes maintaining the image sensor in a fixed position.

11. The method of claim 1, wherein moving the lens relative to the first stationary target includes moving the lens across a plurality of angles in at least two orthogonal directions.

12. The method of claim 1, wherein moving the electronic device relative to the second stationary target includes moving the electronic device across a plurality of angles in at least two orthogonal directions.

13. A method comprising:
receiving data regarding a relationship between lens movement and image movement from an OIS module in an electronic device, wherein the OIS module includes a lens, an image sensor, and an actuator configured to move the lens relative to the image sensor; and
calibrating gyroscope movement to image movement in the electronic device, wherein calibrating gyroscope movement to image movement includes:
detecting movement of the electronic device relative to a stationary target;
recording gyroscope movement and a direction of an image of the stationary target on the image sensor; and
determining a relationship between gyroscope movement and image movement in the electronic device.

14. The method of claim 13, further comprising:
combining the relationship between lens movement and image movement and the relationship between gyroscope movement and image movement to determine a relationship between gyroscope movement and lens movement.

15. The method of claim 14, wherein the relationship between lens movement and image movement in the OIS module includes a 2×2 rotation matrix, and the relationship between gyroscope movement and lens movement includes a 3×2 rotation matrix.

16. The method of claim 13, wherein the data regarding the relationship between the lens movement and the image movement includes data regarding lens movement across a plurality of angles and corresponding image movement of an image target on the image sensor.

17. A method comprising:
calibrating lens movement to image movement in an optical image stabilization (OIS) module, wherein the OIS module includes a lens, an image sensor, and an actuator configured to move the lens relative to the image sensor, and wherein calibrating the lens movement to image movement comprises:
detecting a stationary target outside the OIS module;
detecting movement of a lens relative to the stationary target;
recording lens movement and a direction of an image of the stationary target on the image sensor; and
determining a relationship between lens movement and image movement in the OIS module; and
providing data regarding the relationship between lens movement and image movement to an electronic device when the OIS module is in the electronic device, wherein the electronic device includes a gyroscope separate from the OIS module, wherein the electronic device is configured to determine a relationship between gyroscope movement and image movement.

18. The method of claim 17, wherein the data regarding the relationship between the lens movement and the image movement in the OIS module includes a rotation matrix.

19. The method of claim 17, wherein the data regarding the relationship between lens movement and image movement in the OIS module includes lens movement across a plurality of angles and corresponding image movement of the stationary target on the image sensor.

20. The method of claim 17, wherein the electronic device is configured to combine the relationship between gyroscope movement and image movement with the relationship between lens movement and image movement to define a relationship between gyroscope movement and lens movement.
